(19) United States
(12) Patent Application Publication
(10) Pub. No.: US 2024/0202837 A1
(43) Pub. Date: Jun. 20, 2024

(54) METHODS AND APPARATUS FOR ASSIGNING USERS TO VIRTUAL WORLD SERVERS BASED ON SOCIAL CONNECTEDNESS

(71) Applicant: Rovi Guides, Inc., San Jose, CA (US)

(72) Inventors: Dhananjay Lal, Englewood, CO (US); Reda Harb, Issaquah, WA (US)

(21) Appl. No.: 18/084,894

(22) Filed: Dec. 20, 2022

(51) Int. Cl. G06Q 50/00; G06F 16/901; G06F 16/908

(52) U.S. Cl. CPC G06Q 50/01; G06F 16/9024; G06F 16/908

(57) ABSTRACT

A method and an apparatus are provided for assigning users to virtual world servers based on social connectedness. One example method includes receiving a request to connect a client device to one of a plurality of virtual world servers and accessing social network connectivity data of a user account associated with the client device. The method further includes identifying a plurality of other user accounts based on the social network connectivity data, ranking the plurality of virtual world servers based on connections with devices associated with the plurality of other user accounts, and connecting the client device to a virtual world server of the plurality of virtual world servers based on the ranking.

### BACKGROUND

The present disclosure relates to a method and an apparatus for receiving a request to connect a client device to one of a plurality of virtual world servers, ranking the plurality of virtual world servers, and connecting the client device to a virtual world server of the plurality of virtual world servers based on the ranking.

### SUMMARY

A live experience in a 3D social world is essentially a massive multiplayer online game (MMOG). MMOGs are typically delivered using client-server architectures. The server holds master copies of all mutable objects (anything that can be changed in the game) and avatars and maintains global knowledge of the game world. Clients connect to the server to receive the necessary information about the game world. Clients perform changes on secondary copies or replicas of mutable objects, while the server arbitrates the result based on inputs of all clients (e.g., which event to change its master copy occurred first). All player updates and player interactions are sent to the server for execution as well as conflict resolution, and the server is responsible for sending object updates to all interested players after the updates have been executed. A drawback of this approach is that even the best-provisioned servers can only support a limited number of players. Each user added to a server increases the simulation computation and the network traffic. A common solution is to add multiple servers to improve scalability. However, this can lead to users who are not currently active in the social world to be thrown into the social world based on system considerations rather than friendship connections in the virtual world. Accordingly, there is a need in the industry to provide methods and arrangements which allow users to enter a virtual world with other users (e.g., friends and/or users with common interest).

A method and an apparatus are described below for connecting a client device to a virtual world server of a plurality of virtual world servers based on a ranking of the plurality of virtual world servers.

In some embodiments, a method is provided in which a request is received (for example, by control circuitry coupled to communication paths and memory) to connect a client device to one of a plurality of virtual world servers. Following on from this, control circuitry accesses social network connectivity data of a user account associated with the client device and subsequently identifies a plurality of other user accounts based on the social network connectivity data. The plurality of virtual world servers is then ranked (for example, by control circuitry) based on connections with devices associated with the plurality of other user accounts. Subsequently, the client device is connected to a virtual world server of the plurality of virtual world servers based on the ranking.

In some embodiments, identifying a plurality of other user accounts based on the social network connectivity data can further comprise receiving metadata from a server, determining, from the metadata, a friendship graph comprising the plurality of other users, and determining, from the metadata, an online friendship graph comprising a subset of the plurality of other users. In some embodiments, ranking the plurality of virtual world servers based on connections with devices associated with the plurality of other user accounts can further comprise determining, from the metadata, a static online friendship graph, or determining, from the metadata, a dynamic online friendship graph.

In some embodiments the online friendship graph can comprise a node for each of the plurality of users and a plurality of vertices coupling the plurality of nodes to indicate friendships between each of the plurality of users. In some embodiments the static online friendship graph can further comprise a first node for a first user and a second node for a second user coupled by a single vertex representing a one-hop friendship connection between the first user and the second user, the first node for the first user and the second node for the second user coupled by two vertices representing a two-hop friendship connection between the first user and the second user. In some embodiments the static node can further comprise the first node for the first user and the second node for the second user coupled by n-vertices representing an n-hop friendship connection between the first user and the second user, wherein a one-hop friendship connection represents a close friendship, and the level of friendship decreases with each hop. In the dynamic online friendship graph each vertex between two nodes can be given a weighting to determine a level of friendship, wherein the weighting is determined based on any one of a time of interaction between two users, frequency of interaction between two users, and/or positivity of interaction between the two users, wherein a higher weighting represents a close friendship and a lower weighting represents a less close friendship.

In some embodiments ranking the plurality of virtual world servers based on connections with devices associated with the plurality of other user accounts can further comprise determining, based on the level of friendship between the user of the client device and each of the plurality of users in the online friendship graph, a level of friendship between the user and each of the plurality of users in each virtual world server of the plurality of world servers. Ranking the plurality of virtual world servers based on connections with devices associated with the plurality of other user accounts can further comprise ranking each of the plurality of virtual world servers based on the number of close friendships, wherein the virtual world server with the highest number of close friendships is given the highest ranking and the virtual world server with the lowest number of close friendships is given the lowest ranking.

In some embodiments at least one behavioral characteristic of the plurality of users can be determined from the metadata. The at least one behavioral characteristic may comprise any one of a period of time spent online, a period of time spent in any one of the plurality of virtual world servers, and/or a level of interaction with other users of the plurality of users. Following on from this, it can be determined, based on the at least one behavioral characteristic, that at least one of the plurality of users in the connected virtual world server is a lurker. If at least one of the plurality of users in the connected virtual world server is determined to be a lurker, the system can remove the lurker while calculating connectedness in an online friendship graph. For example, a request can be sent to disconnect a client device of the lurker from the virtual world server. Subsequently, a request can be sent to re-connect the client device of the lurker to a different one of the plurality of virtual world servers. If the spot taken by the lurker in the different one of the plurality of virtual world servers is needed for a different client device (for example, a non-lurker) then the client device of the lurker can be re-connected to yet another one of the plurality of virtual servers. That is to say, another request can be sent to disconnect the client device of the lurker from the different one of the plurality of virtual world servers and, subsequently, a request can be sent to connect the client device of the lurker to yet a different one of the plurality of virtual world servers. Connecting the client device of the lurker to any one of the plurality of virtual world serves is done if at least one of a plurality of parameters (for example, security, proximity and bandwidth requirements) of the different virtual world server are within a predetermined threshold.

In some embodiments, connecting the client device to a virtual world server of the plurality of virtual world servers based on the ranking can further comprise identifying at least one parameter for each of the plurality of virtual world servers, determining the virtual world server of the plurality virtual world servers with the highest ranking, connecting the client device to the virtual world server with the highest ranking if the at least one parameter of the virtual world server with the highest ranking is above a predetermined threshold, and connecting the client device to a virtual world server with a lower ranking if the at least one parameter of the virtual world server with the highest ranking is below the predetermined threshold. The at least one parameter can comprise any one of a security threshold, a proximity threshold, and a bandwidth threshold.

In some embodiments each of the plurality of virtual world servers where the at least one parameter is above the predetermined threshold can be identified, based on the at least one parameter identified for each of the plurality of virtual servers. Following on from this, each of the plurality of virtual world servers where the at least one parameter is above the predetermined threshold can be presented for display, based on the ranking of the plurality of virtual world servers. A user input can be received, at the client device, and following on from this the client device can be connected (based on the user input) to a virtual world server of the plurality of virtual world servers where the at least one parameter is above the predetermined threshold.

In some embodiments, subsequent to connecting the client device to a virtual world server of the plurality of world servers, a loss of connection between the client device and the virtual world server of the plurality of virtual world servers can be determined. If the loss of connection was below a predetermined threshold period of time, the client device can be connected to the same virtual world server of the plurality of world servers. If the loss of connection was above a predetermined threshold period of time the client device can be connected to a different virtual world server of the plurality of world servers.

In some embodiments an apparatus is provided which comprises a memory storing instructions, communication paths, and control circuitry coupled to the communication paths and the memory. The control circuitry is configured to execute the instructions to connect a client device to one of a plurality of virtual world servers. Following on from this, the control circuitry accesses social network connectivity data of a user account associated with the client device and subsequently identifies a plurality of other user accounts based on the social network connectivity data. The plurality of virtual world servers is then ranked (for example, by control circuitry) based on connections with devices associated with the plurality of other user accounts. Subsequently, the client device is connected to a virtual world server of the plurality of virtual world servers based on the ranking.

It should be noted that the methods, apparatuses, and/or aspects described above may be applied to, or used in accordance with, other systems, methods, apparatuses, and/or aspects described in this disclosure.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example scenario of assigning a user to a virtual world based on social connectedness, in accordance with some embodiments of the disclosure;

FIG. 2 shows an example online friendship graph at a server, in accordance with some embodiments of the disclosure;

FIG. 3 shows sharded based servers and region-based servers, in accordance with some embodiments of the disclosure;

FIG. 4 shows an example system of assigning a user to a virtual world based on social connectedness, in accordance with some embodiments of the disclosure;

FIG. 5 shows a block diagram of a media device and of control circuitry comprising a processor and memory, in accordance with some embodiments of the disclosure;

FIG. 6 shows a block diagram of an illustrative media system, in accordance with some embodiments of the disclosure;

FIG. 7 shows a flowchart of illustrative steps involved in assigning a user to a virtual world based on social connectedness, in accordance with some embodiments of the disclosure;

FIG. 8 shows another flowchart of illustrative steps involved in assigning a user to a virtual world based on social connectedness, in accordance with some embodiments of the disclosure;

FIG. 9 shows another flowchart of illustrative steps involved in assigning a user to a virtual world based on social connectedness, in accordance with some embodiments of the disclosure;

FIG. 10 shows another flowchart of illustrative steps involved in assigning a user to a virtual world based on social connectedness, in accordance with some embodiments of the disclosure;

FIG. 11 illustrates an example lifecycle of friendship between two users, in accordance with some embodiments of the disclosure;

FIGS. 12A and 12B illustrate two separate servers to demonstrate a new user entering a virtual world, in accordance with some embodiments of the disclosure; and

FIG. 13 illustrates a user interface involved in maximizing a likelihood of interaction with users, in accordance with some embodiments of the disclosure.

### DETAILED DESCRIPTION

Methods and apparatus are described herein for connecting a client device to a virtual world server of a plurality of virtual world servers based on a ranking of the plurality of virtual world servers. The disclosed methods and systems may be implemented on one or more computing devices. As referred to herein, the computing device can be any device comprising a processor and memory, for example, a television, a smart television, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, a smartwatch, an augmented reality device, a mixed reality device, a virtual reality device, or any other television equipment, computing equipment, or wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, random access memory (RAM), a solid-state drive (SSD) etc.

Live experiences in metaverse social worlds are delivered by virtual machines that are like gaming servers. Typically, a single server can handle a small number of users (e.g., 20-200) each of which have an avatar that is moving in the space. To handle a large number of users, such as in a virtual reality (VR) concert, a load balancer (e.g., as described below) can assign different users to different servers such that the load across the servers is equally distributed. In this manner the load balancer can balance the compute load of simulation, as well as the ingress and egress traffic (e.g., bandwidth requirements). The problem with this approach is that only the users that are assigned to the same server can interact with each other. The users may either get an invitation to join a live social experience with a friend, otherwise they get clubbed with strangers.

Examples of live social experiences are virtual concerts in VR inside of social worlds (e.g., VRChat and Horizon Venues). Another example may be an exploration of a virtual world (e.g., Decentraland and Sandbox). In a relatable but dissimilar example, users may set up a private server (e.g., Minecraft) to interact with each other, while precluding the entry of strangers. Another example is a virtual concert platform (e.g., from Wave) which uses broadcast technology that allows artists to perform live for their fans around the world through different digital channels. The artist transforms into a digital avatar on a virtual stage and the avatar is customized to accurately represent the artist's style and actions. Fans also appear as avatars in the audience and can chat with other attendees around them using VR and PC desktop apps (accessible, for example, with Oculus Rift, Windows Mixed Reality, and other devices). Such concert can have record-breaking attendances of 10 million users or more at the same time. However, with the current technology only a limited number of users within the virtual concert platform (typically, 100 at a time) are able to see other people around them and interact with them. This limitation of 100 at a time comes from the ability of a single server to handle only a limited number of users.

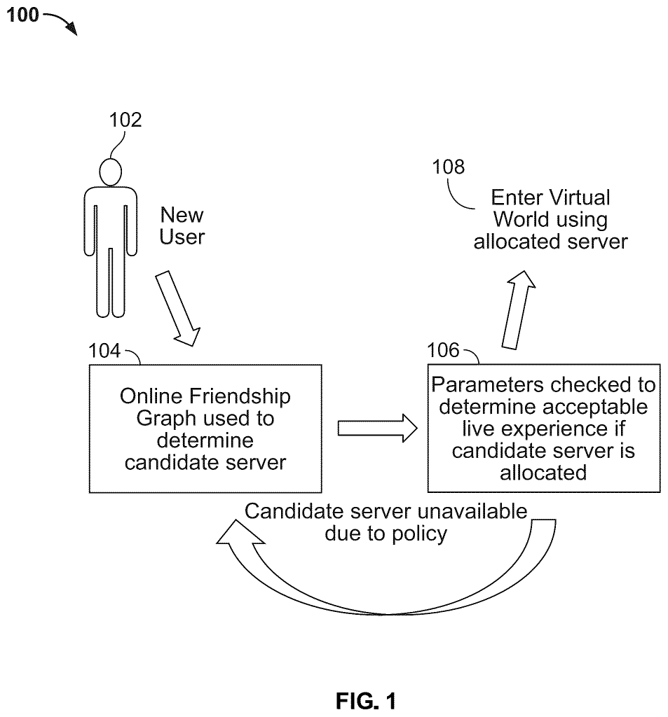

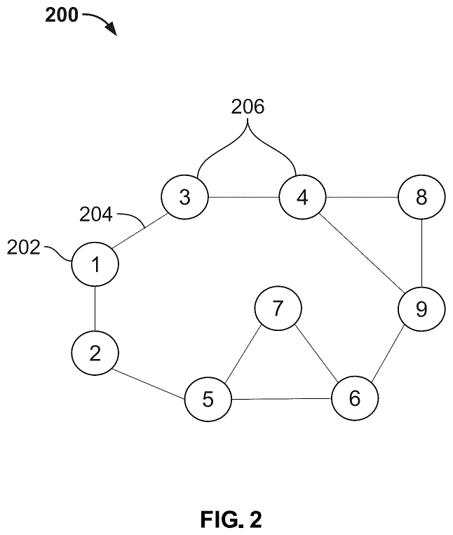

FIG. 1 shows an example scenario 100 of assigning a new user 102 to a virtual world 108 based on social connectedness as well as on system considerations, in accordance with some embodiments of the disclosure. For example, when a new user 102 decides to enter virtual world 108, the social connectedness of the user 102 may be determined by mapping an online friendship graph 104 of the user and using that online friendship graph to determine a candidate server. Further details to the online friendship graph 104 are explained below with reference to FIGS. 2, 7 to 10, and 11. Once a candidate server has been found, a second process can take place wherein parameters of the candidate server (e.g., security, proximity and bandwidth requirements) are checked. If the parameters of the candidate server are determined to be acceptable for a live experience, the user 102 is entered into the virtual world 108 using the allocated server. If the parameters of the candidate server are determined not to be acceptable for a live experience (e.g., a secure link cannot be established, the server is too far away, and/or the bandwidth does not meet the minimum threshold requirements) then the candidate server is deemed unavailable and a different candidate server is chosen, based on the online friendship graph.

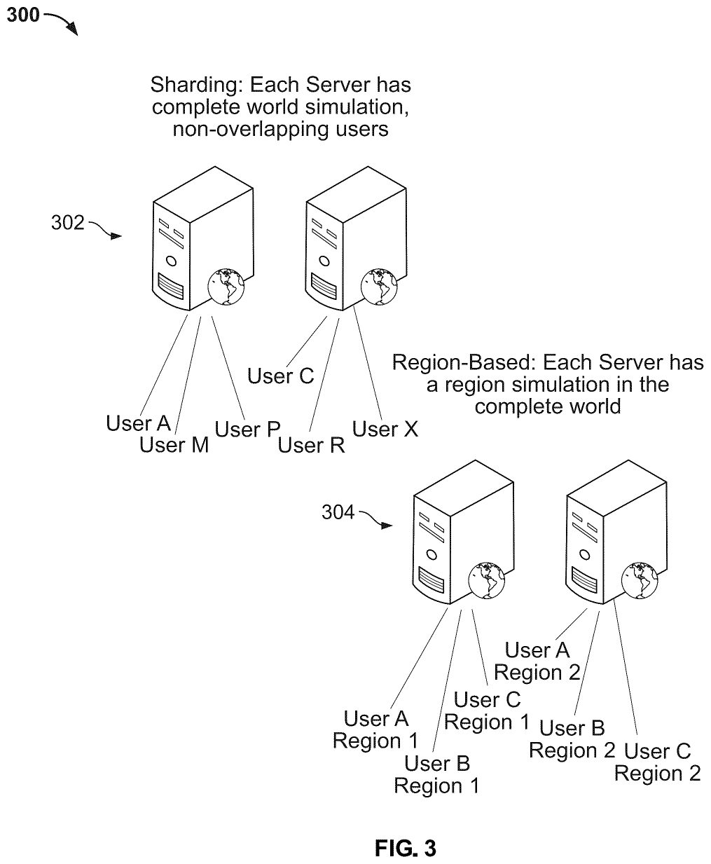

Advantageously, a user can be part of a community in a social world with a server architecture (e.g., a sharded multi-server architecture as described below with reference to FIG. 3), without the need to create a long, unmanageable list of friends a priori. This mirrors real interaction between people.

FIG. 2 shows an example online friendship graph 200 at a server, in accordance with some embodiments of the disclosure. Online friendship graph 200 is a sub-set of a friendship graph, wherein a friendship graph models friendships between a plurality of users in a virtual world 108 and the online friendship graph 200 represents the plurality of users within the friendship graph that are online at a point in time (e.g., already within the virtual world 108 or otherwise currently active on social media or the internet). Online friendship graph 200 is modelled based on nodes 202, 206 and vertices 204. Nodes 202, 206 represent the users in the online friendship graph and vertices (or edges) 204 represent friendships between the plurality of users 202, 206. Within a plurality of servers, each server can have its own online friendship graph 200, thereby allowing for the online friendship graphs (and thus, the plurality of servers) to be ranked, based on the number of friends and/or closeness of friendships of the plurality of users within a server to a new user (e.g., user 102).

The vertices 204 of the graph may be connected (e.g., there is a path from any vertex or user to any other vertex or user) or, in rare cases, disjoint. In FIG. 2 a connected graph is shown as an example, however, other graphs are also envisioned. Online friendship graph 200 shows that User 2, who is online, has friends 1 and 5 online. User 5 has friends 2, 7 and 6 online, User 9 has friends 6, 4 and 8 online, all on the same server. If a user decides to jump into this social world, and has not deliberatively chosen to join a friend in that social world (e.g., a friend is not online, or the user wants to interact with a community rather than a friend) then the system can choose a server for him/her that maximizes the number of online users 202, 206 connected to this user by a maximum n hops (where n is a system parameter). Friendships within an online friendship graph (for example, online friendship graph 200) can be measured as static friendship graphs, as dynamic friendship graphs, or as a combination of the two to allow more flexible selection of the candidate server. Static friendship graphs and dynamic friendship graphs are described below in more detail.

As described in more detail below, a load balancer can combine parameters (e.g., (e.g., security, proximity and bandwidth requirements) to allocate a server to the new user 102 together with the online friendship graphs 200 (of servers) in choosing a candidate server for a new user. System parameters (or system policies) may be driven by server availability or Quality-of-experience (QoE) parameters or both. The load balancer can first maximize the online users connected to the new user 102 by a maximum n hops to determine a candidate server, and can subsequently check that server's parameters to ensure that the new user 102 will have a good experience on the chosen candidate server. In so doing, the load balancer can have maximized interaction opportunities while also ensuring the new user 102 has an acceptable experience. If the first candidate server does not meet the parameter requirements, then a second (e.g., the next best candidate) server can be chosen using its online friendship graph 200. The parameters of the next best candidate server are checked once again, and the process repeats until a server is found for the new user.

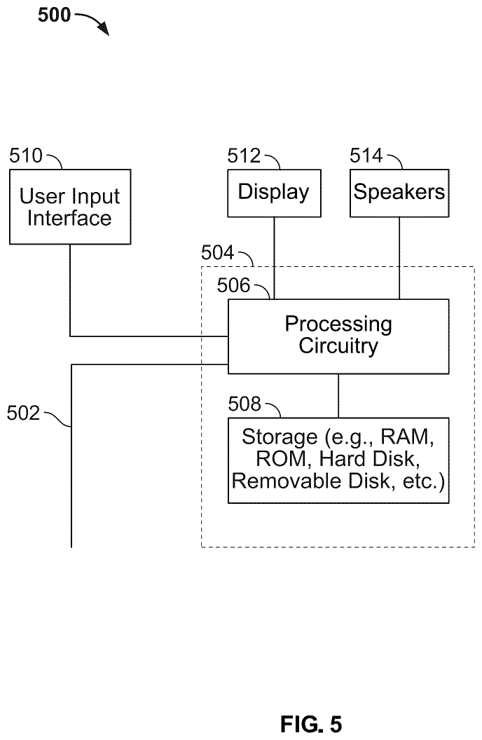

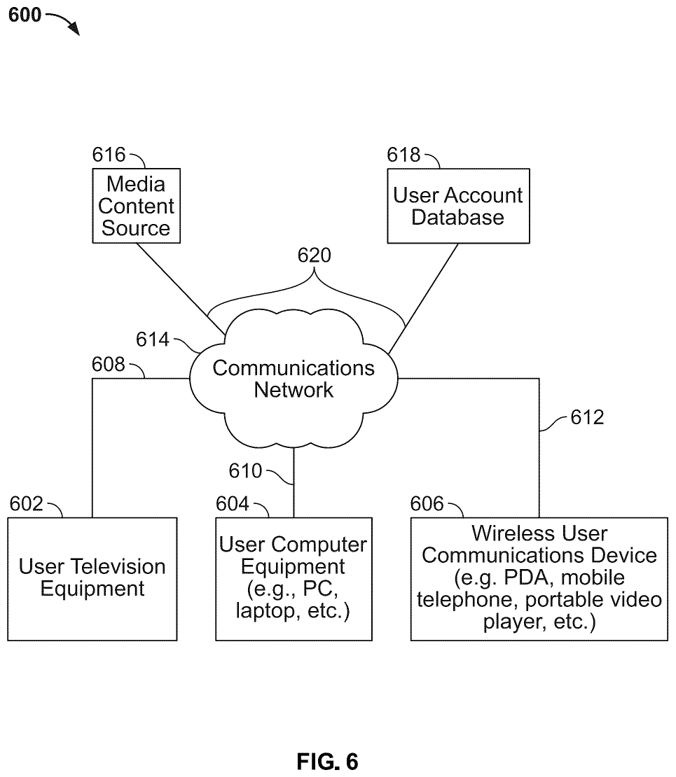

Online friendship graph 200 is maintained by a system (e.g., a server or a plurality of servers) which can be stored on a device (such as described below with reference to FIG. 5), a server (such as described below with reference to FIG. 6) or any combination thereof. The system can model each of the plurality of user's friendships in a virtual world 108, while also capturing proximity (e.g., closeness of friendship) to other users that may not be their friends. The online friendship graph 200 of each server is available to the load balancer. The load balancer can use these online friendship graphs to allocate the new user 102 requesting to enter the social world 108 to a particular server by maximizing connectedness of the new user 102 with online friends, online friends of friends, online friends of friends of friends etc. As a corollary, when applied recursively, the load balancer can allocate the new user 102 to a server without the need for a first user to specify a specific second user that they want to be with. Accordingly, interaction opportunities are maximized between online people who are not only 1-hop connected (e.g., close friends), but also n-hop connected in the online friendship graph 200 (e.g., for each new entering user, every server mimics a community of connected users). This helps facilitate the creation of a community or tribe.

FIG. 3 shows two categories of multi-server architectures 300: sharded based servers 302 and region-based servers 304, in accordance with some embodiments of the disclosure. In sharded-based servers 302 (also known as “sharding”) several complete instances of a virtual world 108 (e.g., a game world) exist, which are also called shards. Each shard is maintained by a server. Every server is responsible for a different set of clients (e.g., users) and has a complete copy of the virtual world 108. That is, each set of clients (e.g., users) and their server follow the traditional client-server architecture. There is usually no need for communication between these servers. On region-based servers 304 only a single virtual world 108 exists that is divided into several regions (e.g., virtual regions). Each region is maintained by a separate server. Users are all in the same virtual world 108, however, in most virtual worlds 108 they are only able to interact with other users in the same region. Users are allowed to move between regions but this requires support for a hand-off mechanism between servers which can be transparent to the player.

Sharding 302 is predominantly used as a multi-server architecture because it has some advantages over the region-based technique (e.g., predictably capping the number of players can lead to more predictable experiences for controlling QoE (and lag)). Player Handoff to another server (e.g., another regional-based server 304) is often quite cumbersome. Furthermore, if the virtual world 108 is not expansive, it may be hard to ensure a more uniform distribution of users across regions in the game world, and the region-based technique is not a good choice. In virtual worlds 108, users typically associate in the metaverse for social interaction, conducting trade, enjoying an experience virtually as if they were physically together. These worlds are expected to model real human behavior but in a fantasy land. Real-world interaction is modeled as a community or a tribe, where people not only interact with their friends, but also friends of friends or people they come to know of through others. If people only jump into a metaverse or social world with friends in a region-based server 304 (as opposed to communities which are possible within sharding 302), they miss opportunities to interact with others and grow their friend circle. This restricts the utility of the metaverse platform. Social worlds allow users to associate their friends' accounts with their user accounts. By accepting an invitation to join their friends' explorations, users can then free-roam these social worlds with their friends. They can go to a theme park, casino or play other games while enjoying the company of their friends in a social metaverse like Decentraland or Sandbox. In some worlds, one user can form a “convoy”, and their friends can join them. A problem with the current sharded based server 302 structure is that if a new user's 102 friends are not currently active in the social world, or the new user 102 does not pick a specific friend or convoy to join, the new user 102 will be thrown into the experience based on system considerations. Sharding 302 in combination with the use of a load balancer as described above and below can allow a new user 102 to join the virtual world 108 with friends or groups of people with common interests.

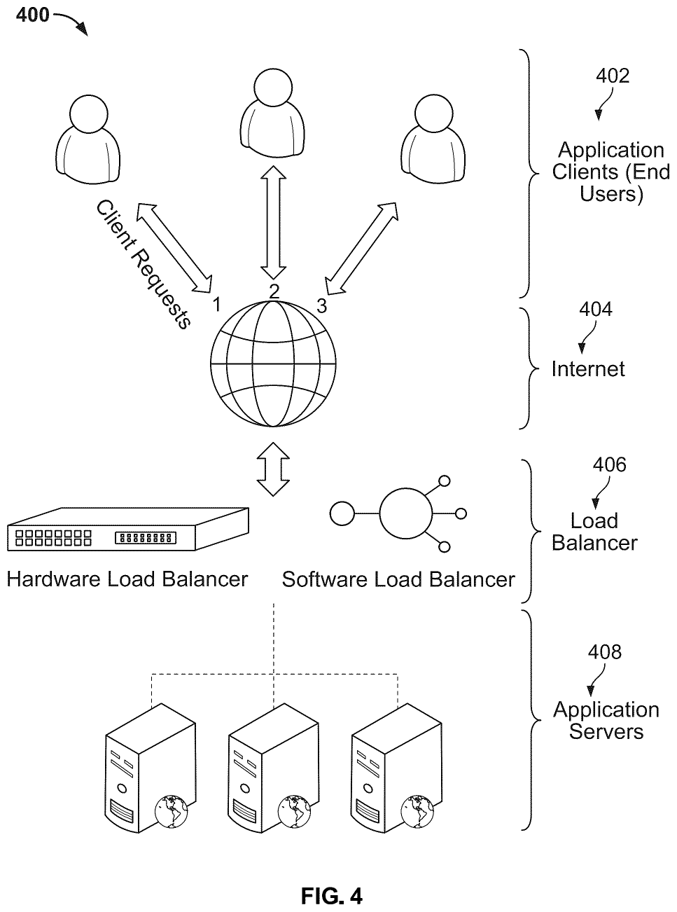

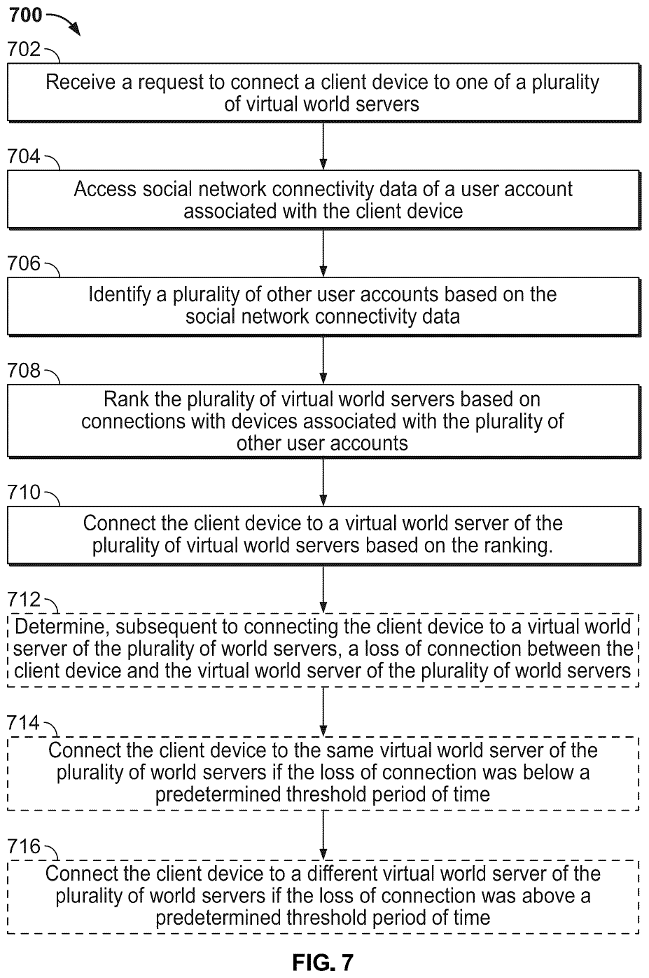

FIG. 4 an example system 400 of assigning a user to a virtual world 108 based on social connectedness, in accordance with some embodiments of the disclosure. Application clients 402 or end users 402 (for example, a new user 102 entering the virtual world 108 as well as all the other users in the virtual world 108) can send out client request services to application servers 408 (for example, as described below with reference to FIG. 6). Before the client request services are sent to the application servers 408, they initially reach the internet 404 (e.g., a communications network as described below with reference to FIG. 6) and are then forwarded (e.g., by way of wired or wireless communication paths) to a load balancer 406. The load balancer 406 can be a hardware load balancer or a software load balancer. The load balancer 406 can match a client request with a server 408 based on configured parameters/policies. The parameters/policies are set based on various considerations, including security, location (proximity), ensuring that the servers 408 are relatively equally loaded (i.e., one server is not being crushed by the requests, while others are idling), failover (redundancy) etc. A sharded multi-server architecture 302 can have parameters/policies based on which a new user shall be allocated to an existing server. As described above with reference to FIG. 2 and in more detail below, a new user's 102 friends and connections can be modeled as a graph (e.g., online friendship graph 200). In addition to the parameters/policies, the online friendship graph 200 can be a further input to the load balancer 406 logic for choosing a candidate server 408, when a new user 102 requests entry into a social world. This is described in more detail below with reference to FIGS. 7 to 11.

FIG. 5 shows a block diagram of a media device 500 and of control circuitry comprising a processor and memory, in accordance with some embodiments of the disclosure. Users (e.g., new user 102) may access media content from the virtual world 108 on a media device 500 from one or more of their user equipment devices 500. FIG. 5 shows a generalized embodiment of illustrative user equipment device 500. More specific implementations of user equipment devices are discussed below in connection with FIG. 6. User equipment device 500 may receive content and data via input/output (“I/O”) path 502. I/O path 502 may provide content (for example, broadcast programming, on-demand programming, Internet content, content available over a local area network (LAN) or wide area network (WAN), and/or other content) and data to control circuitry 504, which includes processing circuitry 506 and storage 508. Control circuitry 504 may be used to send and receive commands, requests, and other suitable data using I/O path 502. I/O path 502 may connect control circuitry 504 (and specifically processing circuitry 506) to one or more communication paths (as described below with reference to FIG. 6). I/O functions may be provided by one or more of these communication paths, but are shown as a single path in FIG. 5 to avoid overcomplicating the drawing.

Control circuitry 504 may be based on any suitable processing circuitry such as processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (for example, dual-core, quad-core, hexa-core, or any suitable number of cores) or supercomputer. In some embodiments, processing circuitry may be distributed across multiple separate processors or processing units, for example, multiple of the same type of processing units (for example, two Intel Core i7 processors) or multiple different processors (for example, an Intel Core i5 processor and an Intel Core i7 processor).

In client/server-based embodiments, control circuitry 504 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths (which are described below in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 508 that is part of control circuitry 504. In some embodiments, storage 508 may me coupled to processing circuitry 506 (for example, by I/O communication paths). As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 508 may be used to store various types of content described herein as well as media guidance data described below. Nonvolatile memory may also be used (for example, to launch a boot-up routine and other instructions). Cloud-based storage, described in relation to FIG. 6, may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (for example, for converting over-the-air, analog, or digital signals to MPEG signals for storage) may also be provided. Control circuitry 504 may also include scaler circuitry for upconverting and downconverting content into the preferred output format of the user equipment 500. Control circuitry 504 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (for example, watch and record functions, picture-in-picture (PIP) functions, multiple-tuner recording, etc.). If storage 508 is provided as a separate device from user equipment 500, the tuning and encoding circuitry (including multiple tuners) may be associated with storage 508.

A user may send instructions to control circuitry 504 using user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of user equipment device 500. For example, display 512 may be a touchscreen or touch-sensitive display. In such circumstances, user input interface 510 may be integrated with or combined with display 512. Display 512 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 512 may be HDTV-capable. In some embodiments, display 512 may be a 3D display, and the interactive media guidance application and any suitable content may be displayed in 3D. A video card or graphics card may generate the output to the display 512. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 504. The video card may be integrated with the control circuitry 504. Speakers 514 may be provided as integrated with other elements of user equipment device 500 or may be stand-alone units. The audio component of videos and other content displayed on display 512 may be played through speakers 514. In some embodiments, the audio may be distributed to a receiver (not shown), which processes and outputs the audio via speakers 514.

The guidance application may be implemented using any suitable architecture. For example, it may be a stand-alone application wholly-implemented on user equipment device 500. In such an approach, instructions of the application are stored locally (for example, in storage 508), and data for use by the application is downloaded on a periodic basis (for example, from an out-of-band feed, from an Internet resource, or using another suitable approach). Control circuitry 504 may retrieve instructions of the application from storage 508 and process the instructions to generate any of the displays discussed herein. Based on the processed instructions, control circuitry 504 may determine what action to perform when input is received from input interface 510. For example, movement of a cursor on a display up/down may be indicated by the processed instructions when input interface 510 indicates that an up/down button was selected.

In some embodiments, the media guidance application is a client-server based application. Data for use by a thick or thin client implemented on user equipment device 500 is retrieved on-demand by issuing requests to a server remote from the user equipment device 500. In one example of a client-server based guidance application, control circuitry 504 runs a web browser that interprets web pages provided by a remote server. For example, the remote server may store the instructions for the application in a storage device. The remote server may process the stored instructions using circuitry (for example, control circuitry 504) and generate the displays discussed above and below. The client device may receive the displays generated by the remote server and may display the content of the displays locally on equipment device 500. This way, the processing of the instructions is performed remotely by the server while the resulting displays are provided locally on equipment device 500. Equipment device 500 may receive inputs from the user via input interface 510 and transmit those inputs to the remote server for processing and generating the corresponding displays. For example, equipment device 500 may transmit a communication to the remote server indicating that an up/down button was selected via input interface 510. The remote server may process instructions in accordance with that input and generate a display of the application corresponding to the input (for example, a display that moves a cursor up/down). The generated display is then transmitted to equipment device 500 for presentation to the user.

In some embodiments, the media guidance application is downloaded and interpreted or otherwise run by an interpreter or virtual machine (run by control circuitry 504). In some embodiments, the guidance application may be encoded in the ETV Binary Interchange Format (EBIF), received by control circuitry 504 as part of a suitable feed, and interpreted by a user agent running on control circuitry 504. For example, the guidance application may be an EBIF application. In some embodiments, the guidance application may be defined by a series of JAVA-based files that are received and run by a local virtual machine or other suitable middleware executed by control circuitry 504. In some of such embodiments (for example, those employing MPEG-2 or other digital media encoding schemes), the guidance application may be, for example, encoded and transmitted in an MPEG-2 object carousel with the MPEG audio and media item of a schedule.

FIG. 6 a block diagram of an illustrative media system 600, in accordance with some embodiments of the disclosure implementing a user device (such as the user device 500 as depicted in FIG. 5 above) as a user television equipment 602, user computer equipment 604, wireless user communications device 606, or any other type of user equipment suitable for accessing content, such as a non-portable gaming machine. The user television equipment 602, user computer equipment 604, wireless user communications device 606, or any other type of user equipment suitable for accessing content may be substantially similar to user device 500 as described above with reference to FIG. 5. For simplicity, these devices may be referred to herein collectively as user equipment or user equipment devices and may be substantially similar to user equipment devices described below. User equipment devices, on which a media guidance application may be implemented, may function as stand-alone devices or may be part of a network of devices. Various network configurations of devices may be implemented and are discussed in more detail below.

A user equipment device utilizing at least some of the system features described above in connection with FIG. 5 may not be classified solely as user television equipment 602, user computer equipment 604, or a wireless user communications device 606. For example, user television equipment 602 may, like some user computer equipment 604, be Internet-enabled, allowing for access to Internet content, while user computer equipment 604 may, like some television equipment 602, include a tuner allowing for access to television programming. The media guidance application may have the same layout on various different types of user equipment or may be tailored to the display capabilities of the user equipment. For example, on user computer equipment 604, the guidance application may be provided as a web site accessed by a web browser. In another example, the guidance application may be scaled down for wireless user communications devices 606.

In system 600, there is typically more than one of each type of user equipment device but only one of each is shown in FIG. 6 to avoid overcomplicating the drawing. In addition, each user may utilize more than one type of user equipment device and also more than one of each type of user equipment device.

In some embodiments, a user equipment device (for example, user television equipment 602, user computer equipment 604, wireless user communications device 606) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (for example, user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 614. Namely, user television equipment 602, user computer equipment 604, and wireless user communications device 606 are coupled to communications network 614 via communication paths 608, 610, and 612, respectively. Communications network 614 may be one or more networks including the Internet, a mobile phone network, mobile voice or data network (for example, a 4G or LTE network), cable network, public switched telephone network, or other types of communications network or combinations of communications networks. Paths 608, 610, and 612 may separately or together include one or more communication paths, such as, a satellite path, a fiber-optic path, a cable path, a path that supports Internet communications (for example, IPTV), free-space connections (for example, for broadcast or other wireless signals), or any other suitable wired or wireless communication path or combination of such paths. Paths 608, 610, and 612 may each be a wireless path or wired path. Communications with the user equipment devices may be provided by one or more of these communication paths but are shown as a single path for each device in FIG. 6 to avoid overcomplicating the drawing.

Although communication paths are not drawn between user equipment devices, these devices may communicate directly with each other via communication paths, such as those described above in connection with paths 608, 610, and 612, as well as other short-range point-to-point communication paths, such as USB cables, IEEE 1394 cables, wireless paths (for example, Bluetooth, infrared, IEEE 802-1 1×, etc.), or other short-range communication via wired or wireless paths. BLUETOOTH is a certification mark owned by Bluetooth SIG, INC. The user equipment devices may also communicate with each other directly through an indirect path via communications network 614.

System 600 includes media content source 616 and user account database 618 coupled to communications network 614 via communication paths 620, respectively. User account database 618 may store the plurality of friendship graphs and online friendship graphs 200 as mentioned above with reference to FIG. 2 and below. Path 620 may include any of the communication paths described above in connection with paths 608, 610, and 612.

Communications with the media content source 616 and user account database 618 may be exchanged over one or more communication paths but are shown as a single path in FIG. 6 to avoid overcomplicating the drawing. In addition, there may be more than one of each of content source 616 and user account database 618, but only one of each is shown in FIG. 6 to avoid overcomplicating the drawing. (The different types of each of these sources are discussed below.) If desired, media content source 616 and user account database 618 may be integrated as one source device. Although communications between sources 616 and 618 with user equipment 602, 604, and 606 are shown as through communications network 614, in some embodiments, sources 616 and 618 may communicate directly with user equipment 602, 604, and 606 via communication paths (not shown) such as those described above in connection with paths 608, 610, and 612.

Media content source 616 may include one or more types of content distribution equipment including a television distribution facility, cable system headend, satellite distribution facility, programming sources (for example, television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 616 may be the originator of content (for example, a television broadcaster, a Webcast provider, etc.) or may not be the originator of content (for example, an on-demand content provider, an Internet provider of content of broadcast schedules for downloading, etc.). Media content source 616 may include cable sources, satellite providers, on-demand providers, Internet providers, over-the-top content providers, or other providers of content. Media content source 616 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

User Account Database 618 is optionally coupled to communications network 614 and may comprise a database of user accounts, their preferences and which genres of media asset they are interested in. Each user account may update their preferences and interested genres on the user preference database at any point. User Account Database 618 may further comprise the plurality of friendship graphs and online friendship graphs 200 for each of the plurality of servers within the virtual world 108, as described above.

In addition to this, system 600 may include a media guidance data source (not shown). Media guidance data source be coupled to communications network 614 via communications path 620. Communications with the media content source 616 and user account database 618 and the media guidance data source may be exchanged over one or more communication paths. Media guidance data source may provide media guidance data, such as the media guidance data described above and below. Media guidance data may be provided to the user equipment devices using any suitable approach. In some embodiments, the guidance application may be a stand-alone interactive television program guide that receives program guide data via a data feed (for example, a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source may be provided to users' equipment using a client/server approach. For example, a user equipment device may pull media guidance data from a server, or a server may push media guidance data to a user equipment device. In some embodiments, a guidance application client residing on the user's equipment may initiate sessions with source to obtain guidance data when needed, for example, when the guidance data is out of date or when the user equipment device receives a request from the user to receive data. Media guidance may be provided to the user equipment with any suitable frequency (for example, continuously, daily, a user-specified period of time, a system-specified period of time, in response to a request from user equipment, etc.). Media guidance data source may provide user equipment 602, 604, and 606 the media guidance application itself or software updates for the media guidance application.

In some embodiments, the media guidance data may include viewer data. For example, the viewer data may include current and/or historical user activity information (for example, what content the user typically watches, what times of day the user watches content, whether the user interacts with a social network, at what times the user interacts with a social network to post information, what types of content the user typically watches (for example, pay TV or free TV), mood, brain activity information, etc.). The media guidance data may also include subscription data. For example, the subscription data may identify to which sources or services a given user subscribes and/or to which sources or services the given user has previously subscribed but later terminated access (for example, whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (for example, a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 508, and executed by control circuitry 504 of a user equipment device 500. In some embodiments, media guidance applications may be client-server applications where only a client application resides on the user equipment device, and server application resides on a remote server. For example, media guidance applications may be implemented partially as a client application on control circuitry 504 of user equipment device 500 and partially on a remote server as a server application (for example, media guidance data source) running on control circuitry of the remote server. When executed by control circuitry of the remote server (such as media guidance data source), the media guidance application may instruct the control circuitry to generate the guidance application displays and transmit the generated displays to the user equipment devices. The server application may instruct the control circuitry of the media guidance data source to transmit data for storage on the user equipment. The client application may instruct control circuitry of the receiving user equipment to generate the guidance application displays.

Content and/or media guidance data delivered to user equipment 602, 604, and 606 may be over-the-top (OTT) content. OTT content delivery allows Internet-enabled user devices, including any user equipment device described below, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (for example, web-based applications or cloud-based applications), or the content can be displayed by media guidance applications stored on the user equipment device.

Media guidance system 600 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 6.

In one approach, user equipment devices may communicate with each other within a home network. User equipment devices can communicate with each other directly via short-range point-to-point communication schemes described above, via indirect paths through a hub or other similar device provided on a home network, or via communications network 614. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005, which is hereby incorporated by reference herein in its entirety. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (for example, recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with media content source 616 to access content. Specifically, within a home, users of user television equipment 602 and user computer equipment 604 may access the media guidance application to navigate among and locate desirable content. Users may also access the media guidance application outside of the home using wireless user communications devices 606 to navigate among and locate desirable content.

In a fourth approach, user equipment devices may operate in a cloud computing environment to access cloud services. In a cloud computing environment, various types of computing services for content sharing, storage or distribution (for example, video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 614. These cloud resources may include one or more content sources 616, one or more and user account databases 618, and one or more media guidance data sources. In addition or in the alternative, the remote computing sites may include other user equipment devices, such as user television equipment 602, user computer equipment 604, and wireless user communications device 606. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 604 or wireless user communications device 606 having a content capture feature. Alternatively, the user can first transfer the content to a user equipment device, such as user computer equipment 604. The user equipment device storing the content uploads the content to the cloud using a data transmission service on communications network 614. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device.

In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 5.

FIG. 7 is a flowchart 700 of illustrative steps involved in assigning a user to a virtual world based on social connectedness, in accordance with the arrangement described above with reference to FIGS. 1 to 6. At step 702 a request (e.g., a client request received from a user) is received (e.g., at control circuitry as described above with reference to FIGS. 5 and 6) to connect a client device (e.g., a device 500 as described above with reference to FIG. 5 which is associated with a new user 102) to one of a plurality of virtual world servers (for example, one of a plurality of sharded world servers 302, 408 as described above with reference to FIGS. 3, 4 and 6). At step 704, control circuitry may access social network connectivity data of a user account associated with the client device. Social network connectivity data may include online friendship graphs 200 as described above. At step 706, the control circuitry can identify a plurality of other user accounts based on the social network connectivity data. At step 708, the plurality of virtual world servers 302, 408 can be ranked (e.g., by load balancer 406) based on the connections with devices associated with the plurality of other user accounts. At step 710, control circuitry (e.g., load balancer 406) can connect the client device to a virtual world server 302, 408 of the plurality of virtual world servers 302, 408 based on the ranking.

In addition to steps 702 to 710 described above, optional steps 710 to 714 may also be performed. In step 710, subsequent to connecting the client device 500 to a virtual world server 302, 408 of the plurality of virtual world servers 302, 408, control circuitry (e.g., load balancer 406) may determine a loss of connection between the client device 500 and the virtual world server 302, 408 of the plurality of virtual world servers 302, 408. At step 714, the client device 500 may be reconnected to the same virtual world server 302, 408 by control circuitry, if the loss of connection was below a predetermined threshold period of time. At step 716, the client device 500 may be connected to a different virtual world server 302, 408 of the plurality of world servers 302, 408 if the loss of connection was above a predetermined threshold period of time. For example, control circuitry may distinguish between users explicitly ‘leaving’ (such as, selecting an exit option) versus users getting disconnected (such as dropping off due to a connection issue). In the case when a user gets disconnected, the system 400 can reserve the spot for that user (for a predetermined amount of time) in anticipation of that user joining back. This means the load balancer 406 takes the reserved spots into account, and ensures that users who dropped off inadvertently may be able to join their community or tribe again once connection issues are resolved.

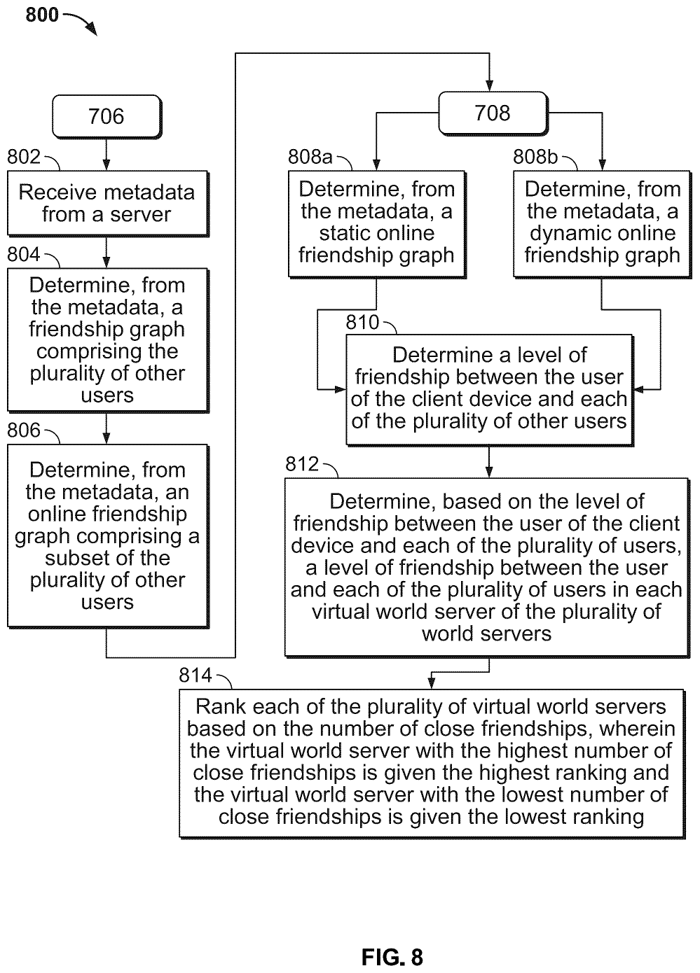

FIG. 8 is a flowchart 800 of illustrative steps involved in assigning a user to a virtual world based on social connectedness which builds on from the features presented in FIG. 7 above, in accordance with the arrangement described above with reference to FIGS. 1 to 7. FIG. 7 starts from step 706 of FIG. 7 wherein the control circuitry can identify a plurality of other user accounts based on the social network connectivity data. Step 802 of FIG. 8 carries on from step 706 wherein the control circuitry (e.g., the load balancer 406) can receive an additional metadata from a server (for example, the user account database 618 as described above with reference to FIG. 6). The additional metadata may include, for example, a list of friends for each of the users within a world server of the plurality of world servers as well as the status (e.g., online, available, busy, offline, etc.) of each user within the world server of the plurality of world servers. In some embodiments the additional metadata may include a list of friends (and/or their status) for each of the users within more than one world server of the plurality of world servers or all of the plurality of world servers. The additional metadata may additionally and/or separately include other information of each user within the friendship graph such as, but not limited to, each user's interests, friends, photos, etc.

At step 804, the control circuitry (e.g., the load balancer 406) may determine, from the metadata (e.g., the list of friends for each user), a friendship graph (as described above with reference to FIG. 2) comprising the plurality of other users. At step 806, the control circuitry (e.g., the load balancer 406) may additionally determine, from the metadata (e.g., the status of each user), an online friendship graph comprising a subset of the plurality of other users (as described in FIG. 2). Subsequently, the method may proceed to step 708 as described above with reference to FIG. 7.

At steps 808a and 808b, following on from step 708, ranking the plurality of virtual world servers based on connections with devices associated with the plurality of other user accounts may further comprise determining, from the metadata, a static online friendship graph 808a or determining, from the metadata, a dynamic online friendship graph 808b. In some examples, a mixture of a static online friendship graph and a dynamic online friendship graph is determined. In some embodiments, a static online friendship graph, a dynamic online friendship graph, or a mixture of the two may be chosen directly by a user 102 entering the virtual world 108.

In a static online friendship graph as determined in step 808a, whenever a user chooses a friend, the system 400 adds a vertex (e.g., vertex 204 as described above with reference to FIG. 2) between the nodes (e.g., nodes 202, 206 as described above with reference to FIG. 2) that represent the plurality of users in the friendship graph (or online friendship graph). Typically, friendships are reciprocal, i.e., if user A chooses user B as a friend, then user B also chooses user A as friend (this may be through explicit action of user B accepting user A's friend request). In this case an undirected graph can built as shown in FIG. 2 through the actions of multiple users choosing and accepting friends (vertices 204 do not have a direction from A to B or 1 to 2, but are reciprocal). Then the online friendship graph for one server is a subgraph of the friendship graph, comprising the users (nodes) and vertices (friendships) of those currently online at that server. Accordingly, in some embodiments, the online friendship graph comprises a node for each of the plurality of users and a plurality of vertices coupling the plurality of nodes to indicate friendships between each of the plurality of users. The static online friendship graph may further comprise a first node for a first user and a second node for a second user coupled by a single vertex representing a one-hop friendship connection between the first user and the second user, the first node for the first user and the second node for the second user coupled by two vertices representing a two-hop friendship connection between the first user and the second user, and the first node for the first user and the second node for the second user coupled by n−2 vertices between them (not counting the first user and the second user) representing an n-hop friendship connection between the first user and the second user. As is discussed in more detail below, a one-hop friendship connection can represent a close friendship, and the level of friendship may decrease with each hop.

When a user (e.g., new user 102) requests entry into the virtual world, the system 400 can temporarily add the new user 102 to the online friendship graph at each server 408 and perform the following steps:
A. The node 202, 206 is added to each of the server's online friendship graphs 200;
B. The vertices 204 from this node 202, 206 to all other nodes are read from the friendship graph and only those vertices 204 are added that connect to an existing node 202, 206 in this server's online friendship graph 200;
C. Using a Breadth First search (BFS) augmented with a depth counter, starting at the temporarily added new user node 202, 206, the system 400 can determine the number of online friends at each level/depth up to a maximum of n hops (system parameter).

D. This is calculated for each server 408. The system 400 can then choose the server 408 that has the largest number of online users connected to the new user 102 by a maximum of n hops in its online friendship graph.

In one embodiment, the system 400 can assign weights to nodes 202, 206 based on their proximity to the new user 102 to calculate a “figure of merit” for each server 408. For example, if a node (user) 202, 206 is 1 hop from the new user 102 (i.e., is a friend), then it is assigned a weight of 1, if a node is 2 hops from the new user 102 (i.e., a friend of a friend), then it is assigned a weight of 0.5 (or some number less than/equal to 1) and so on. In this manner, users that are a smaller hop distance away are weighted higher than users at a great hop distance. Then the figure of merit (FoM) for a candidate server is given by the following formula:

FOM=w₁ΣV₁₋_{^{Hop}}+w₂ΣV₂₋_{^{Hop}}+ . . . +WₙΣVₙ₋_{^{Hop}}
where w₁≥w₂≥ . . . ≥wₙ
   Wₙ is the weight assigned to an online user vertex n-Hop distance away from the new (temporary) user Σ_{Vn-Hop} is the number of online vertices (users) at an n-Hop distance from the new (temporary) user. The load balancer 406 can then choose the candidate server 408 with the highest FoM as the best candidate. If that server 408 is unable to meet parameter/policy considerations, the server 408 with the next highest FoM is chosen. This is repeated until a server 408 is found. In some embodiments w₁=w₂= . . . =wₙ, i.e., all the weights are equal regardless of the hop distance of an online user to the new user in the online friendship graph. Once a server 408 is chosen for the new user 102, the new user 102 node 202, 206 is added to that server's online friendship graph 200. It is removed from the other servers' online friendship graphs 200, where it had been temporarily added to calculate the FoM.

A Breadth-first search traversal can be used because the resultant spanning tree has the property that each node 202, 206 is represented by its minimum hop distance from the starting node (i.e., the new user 102). The depth counter ensures that the traversal truncates after n hops starting at the new user node 202, 206.

In a dynamic online friendship graph as determined in step 808b each vertex 204 between two nodes may be given a weighting to determine a level of friendship, wherein the weighting is determined based on a time of interaction between two users, a frequency of interaction between two users, positivity of interaction between the two users, or any combination of the above. The positivity of interaction between the two users may be measured using an automatic speech recognition and/or natural-language-understanding (ASR-NLU) system together with a sentiment analysis system to determine whether an interaction is positive or negative, A higher weighting represents a close friendship and a lower weighting represents a less close friendship.

Further, the friendship vertex 204 between two users can be weighted based on the level or intensity of their friendship, e.g., whether it is renewed in some manner. In some embodiments the weight is a cost, e.g., the greater the weight of the vertex between two users, the less friendly they are to each other. A direct (strong) friendship between two users is given a weight of 1 (or a cost of 1), which is the lowest system cost. In the limit, two users have a vertex 204 with a weight of ∞, which is the equivalent of them being not connected to each other. The system 400 may set the weight of the vertex 204 between two users based on their interaction. Even if a first user does not add a second user as a friend initially, the system 400 determines whether their interaction meets a threshold of friendship (which can be the same threshold as that of a renewal). The system 400 may suggest to two users, based on their interaction, to add each other as friends. Further, even when two users do not meet the threshold for interaction to be friends, the system 400 may still determine a weight for the vertex between them (a value >1). For example, if the time of interaction or togetherness in an experience is used as a metric for determining the weight of a vertex 204 between two users, then the weight of the vertex 204 between users A and B may be:

W_{AB}=(Threshold Engagement time for Friendship/Time of Engagement between users A and B)
Hence, W≥1.

In a different embodiment,

W_{AB}=(Threshold Positivity for Friendship/Positivity of interaction between users A and B)

Initially when two users become friends, the weight of the vertex 204 between them in the friendship graph is 1. The friendship decays with time, until a renewal occurs. The time for which the friendship decays is the time since their previous renewal (typically an interaction of a certain time, or a positive interaction as measured by other means such as ASR-NLU). This decay function can be linearly decreasing with time, exponentially decreasing or modeled using another mathematical relationship. Since the decay function is decreasing with time, then the reciprocal of the decayed value is used to model the weight of the vertex 204. This gives the vertex 204 an increasing value (>1) as the friendship decays. If a renewal occurs, then the weight of the vertex between the two users is returned (decreased back to) to unity (1). Further, once the friendship decays beyond a threshold value (a system parameter), then the friendship vertex 204 between the users can be removed. This optimization reduces the connectedness of the graph, based on the insight that friendships are temporal. The system 400 may present a first user with a prompt that informs them that they have not interacted with a second user, a friend, in some time, and asks them whether they would like to keep the second user as a friend. If the first user provides an affirmative response, then this can be treated as a renewal event (this can also be run reciprocally for the first and the second user to affirm renewal).

Sample exponentially decreasing function

A(t)=A₀·e^{kt}
k is a negative number (system parameter)
t is the time since last renewal
   Weight of the Edge between users whose friendship is modeled as a time-decaying function:

W=1/A(t)

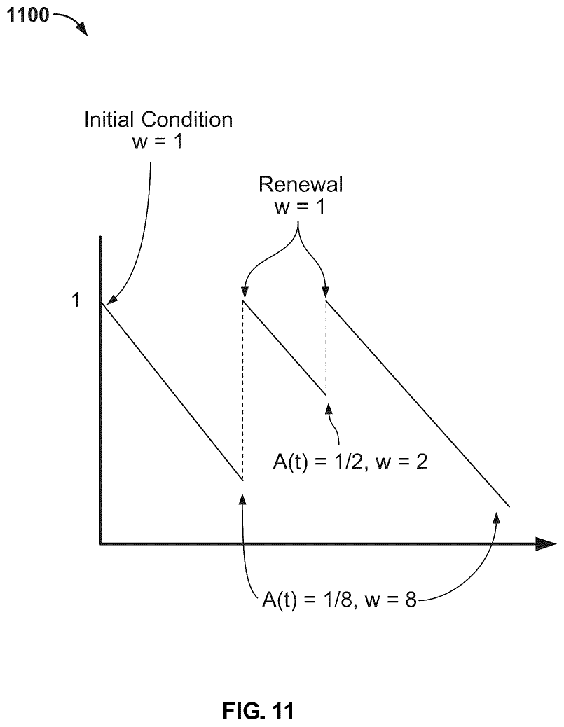

FIG. 11 illustrates an example lifecycle 1100 of friendship between two users. Initially the two users are friends, hence the weight of the vertex 204 between the nodes 204 representing those users is 1. Due to lack of interaction, the friendship decays until the friendship decay function reaches A(t)=1/8 (linear decay shown in this graph). The weight w of the vertex 204 between the user nodes 204 steadily increases and is now w=8. At this point, the users' friendship undergoes a renewal, i.e., they engage with each other significantly. Once again w=1. It decays again until A(t)=1/2, and w increases to 2. In this manner, the weights of the vertices 204 between the vertices 204 in the online friendship graph is continually updated based on temporal information.

Accordingly, at step 810, subsequent to determining from the metadata a static online friendship graph and/or a dynamic online friendship graph at each of the plurality of world servers, the method can determine a level of friendship between the user 102 of the client device 500 and each of the plurality of other users (in each of the plurality of world servers 408). At step 812, it can be determined, based on the level of friendship between the user 102 of the client device and each of the plurality of users, a level of friendship between the user 102 and each of the plurality of users in each virtual world server of the plurality of world servers. At step 814, each of the plurality of virtual world servers can be ranked as (discussed above) based on the number of close friendships, wherein the virtual world server with the highest number of close friendships is given the highest ranking and the virtual world server with the lowest number of close friendships is given the lowest ranking as discussed above.

In some embodiments, the system 400 maintains a friendship graph as well as online friendship graphs 200 for each server 408, available to the load balancer 406. Each online friendship graph has weighted vertices 204 connecting the nodes 202, 206 as discussed above. The higher the weight of a vertex 202, 206, the lower the temporal intensity of the friendship, and the greater the “cost”. The weight of a vertex, i.e., the “cost”, is inversely proportional to the temporal intensity of the friendship. The advantage of this modeling is that well known graph traversal algorithms that use “costs” as weight of vertices can be leveraged to find paths between nodes 204 that incur the least “cost”. The insight related to social behavior is that people are more likely to approve of an association between two of their friends if they are strong friends with each of them. Therefore, incurring a lower “cost” in traversal from a first node to a second node indicates a greater likelihood of the two users (represented by the nodes 202, 206) having a positive interaction when they are online together and being a part of a community or tribe.

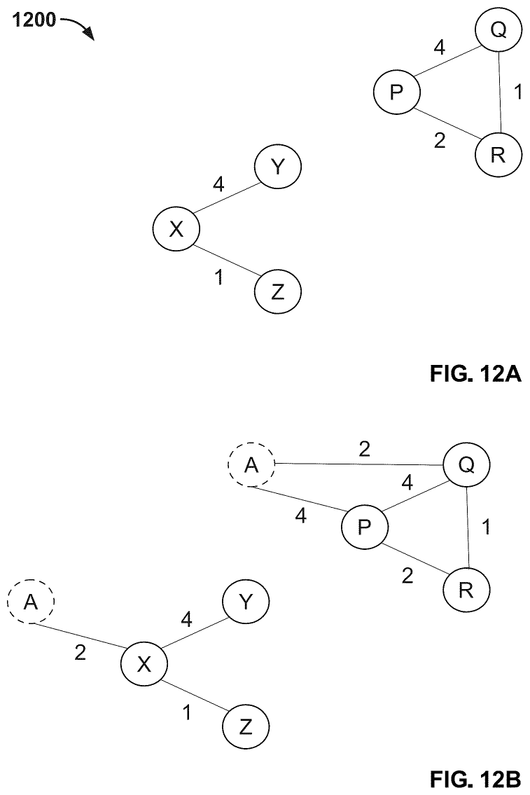

As demonstrated in FIG. 12, when a new user A 102 wants to enter the (live) virtual world, they can be added to each server's online friendship graph 200 as a temporary node 202, 206 (similarly as discussed above). FIG. 12 illustrates two separate servers 1200 to demonstrate this, one with users X, Y and Z in FIG. 12A, and another with users P, Q and R in FIG. 12B. The online friendship graphs associated with each server are shown below. Users X and Z have a renewed/strong friendship as evidenced by their recent engagement with each other. Users X and Y have also interacted, but their interaction has aged/decayed such that temporally a weight of 4 has been assigned. In a similar vein, on the other server, users Q and R are strong friends. While user P has interacted with both users Q and R, his/her friendship with them has decayed. The weights of 4 and 2 with Q and R indicate that user P's friendship with user Q has decayed more than that with user R. The vertices 204 corresponding to user A's friendships with existing users in the servers' online friendship graphs are also added. The system 400 then picks the server that maximizes the number of users connected to the new user such that the “cost” to reach each such user (a measure of connectedness) is less than/equal to a threshold value (the “maximum cost”, a system parameter).

In one embodiment a user-friendly feature presents multiple options to the user 102 where they can choose which server to join based on the existing online users that are connected to them by a maximum hop distance or the “cost” function (as discussed above). For example, the user can be given the option to join (X,Y,Z) or join (P,Q,R). Regardless of how strong the connection is with (X,Y,Z) or (P,Q,R), there may be scenarios where users want to ‘catch up’ and they can use such medium to do so. For instance, the user could talk to X every day, but might want to catch up with user P today.

In one embodiment, a global “influencer graph” is also maintained along with the friendship graph and online friendship graph. Influencers, typically celebrities, do not need to follow their followers. The “influencer graph” is comprised of two types of vertices 204: Directed vertices, e.g., one-way directional link from followers to influencers, and Undirected vertices with friends, i.e., two-way links. Influencers are often connected to each other, and collectively may define a tribe. Users who interact with content from an influencer, such as watching or liking, may be marked as followers. Each server can maintain an “online influencer graph”, available to the load balancer 406. In this case, the system 400 may present an option to the user 102 to join an influencer (or a group of influencers based on connectedness) when they are online and routes the user to a server 408 based on influencers whom he/she follows on a social network. Accordingly, there are two different graphs (e.g., the online friendship graph and the influencer graph) and the server's availability can then be based on connections from both. In one example, a user is online, and receives a notification that an influencer (say 1-hop or 2-hop connected based on the “influencer graph”) has joined the social world. The user may be presented with a choice to “join” the influencer's server.

The system 400 can calculate the “cost” to reach each node 202, 206 in the online friendship graph of a server using the temporary node 202, 206 as the root node. The “maximum cost” beyond which the system shall truncate the algorithm is set as a system parameter. The system then uses a shortest path algorithm (e.g., Dijkstra's algorithm) to calculate the cost to reach each node 202, 206 in the online friendship graph 200, while truncating the algorithm once the sum of “costs” (of all vertices) to (reach) a node exceeds the “maximum cost” threshold value.

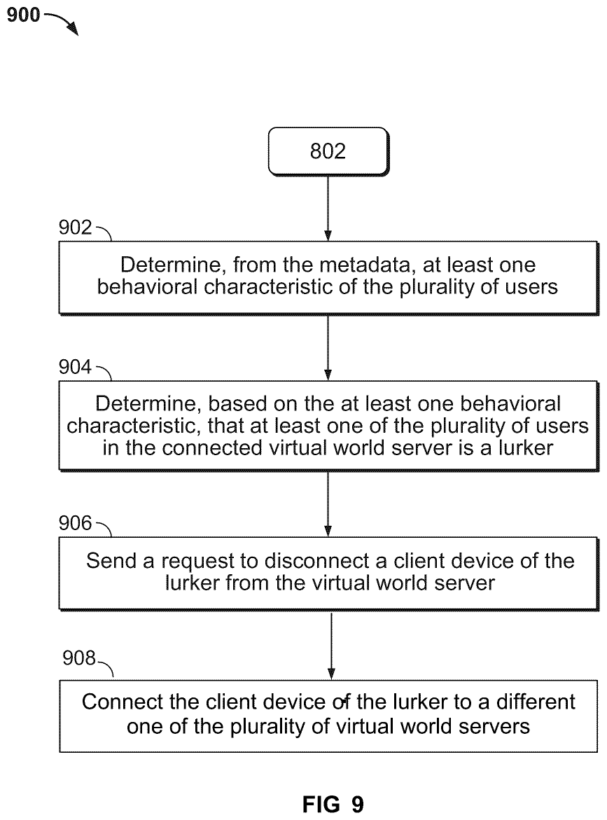

FIG. 9 is a flowchart 900 of illustrative steps involved in assigning a user to a virtual world based on social connectedness which builds on from the features presented in FIG. 8 above, in accordance with the arrangement described above with reference to FIGS. 1 to 8. FIG. 9 starts from step 802 of FIG. 8, wherein metadata is received from a server. At step 902, at least one behavioral characteristic of the plurality of users can be determined from the metadata. The at least one behavioral characteristic comprises any one of a period of time spent online, a period of time spent in any one of the plurality of virtual world servers, and/or a level of interaction with other users of the plurality of users. At step 904, a determination can be made, based on the at least one behavioral characteristic, that at least one of the plurality of users in the connected virtual world server is a lurker. The system can remove the lurker while calculating connectedness in an online friendship graph. At step 906, a request can be sent, from control circuitry, to disconnect a client device of the lurker from the virtual world server. Subsequently, in step 908, a request can be sent to re-connect the client device of the lurker to a different one of the plurality of virtual world servers. If the spot taken by the lurker in the different one of the plurality of virtual world servers is needed for a different client device (for example, a non-lurker) then the client device of the lurker can be re-connected to yet another one of the plurality of virtual servers. That is to say, another request can be sent to disconnect the client device of the lurker from the different one of the plurality of virtual world servers and, subsequently, a request can be sent to connect the client device of the lurker to yet a different one of the plurality of virtual world servers. Connecting the client device of the lurker to any one of the plurality of virtual world serves is done if at least one of a plurality of parameters (for example, security, proximity and bandwidth requirements) of the different virtual world server are within a predetermined threshold. In one embodiment, historical data that relates to how much time users spend in a virtual world environment can be recorded. If a client device (and/or a user, such as a specific username) that was previously identified as a lurker re-enters the virtual world environment the client device can be identified by the system as a lurker upfront, based on the stored historical data and previous stored positive identifications. Subsequent to identifying a lurker upfront, the lurker can be assigned to any available server of the plurality of virtual world servers (for example, any one of the plurality of virtual world servers that meets the predetermined threshold of at least one of the plurality of parameters as described above). Lurkers are defined as users who exhibit behavioral characteristics such that they join and leave virtual worlds frequently without necessarily interacting with other users in servers of virtual worlds. To ensure that the available bandwidth is used efficiently and to ensure a good QoE, the system 400 can make smart decisions to weed out the lurkers based on the behavioral characteristics. For example, if user A has n-hop (or low “cost”) connections to B, C, and D—and D is a ‘lurker’—then the system can remove D while calculating connectedness in an “online friendship graph”. If the system identifies the lurkers, it can allocate them to any server (it is computationally less expensive to assign lurkers to servers).

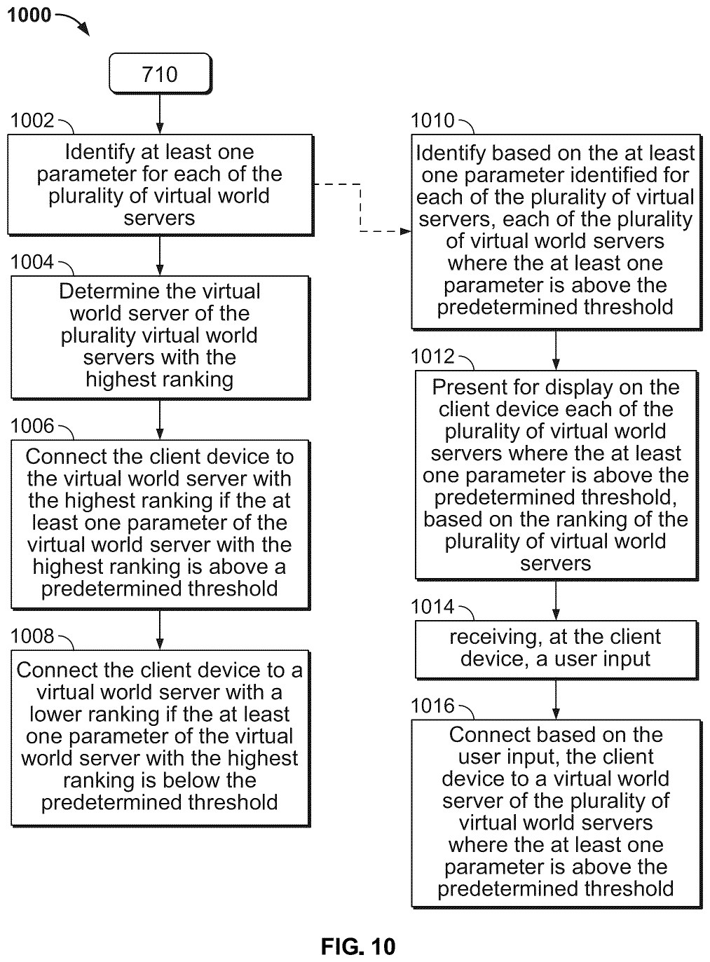

FIG. 10 is a flowchart 1000 of illustrative steps involved in assigning a user to a virtual world based on social connectedness which builds on from the features presented in FIG. 7 above, in accordance with the arrangement described above with reference to FIGS. 1 to 9. FIG. 10 starts from step 710 of FIG. 7, wherein the client device is connected to a virtual world server of the plurality of virtual world servers based on the ranking. At step 1002, the method further identifies at least one parameter for each of the plurality of virtual world servers. The at least one parameter comprises any one of a security threshold, a proximity threshold, and a bandwidth threshold as discussed above. At step 1004, the virtual world server with the highest ranking of the plurality of virtual world servers is determined. At step 1006, the client device can be connected to the virtual world server with the highest ranking if the at least one parameter of the virtual world server with the highest ranking is above a predetermined threshold. At step 1008, the client device can be connected to a different virtual world server with a lower ranking if the at least one parameter of the virtual world server with the highest ranking is below the predetermined threshold.

Optionally, at step 1010, based on the at least one parameter identified for each of the plurality of virtual servers, each of the plurality of virtual world servers where the at least one parameter is above the predetermined threshold can be identified. At step 1012, each of the plurality of virtual world servers where the at least one parameter is above the predetermined threshold, based on the ranking of the plurality of virtual world servers, may be presenting for display on the client device (or any other device, such as the device 500 described above with reference to FIG. 5). At step 1014, a user input may be received at the client device (or any other device, such as the device 500 described above with reference to FIG. 5). At step 1016, based on the user input, the client device can be connected to a virtual world server of the plurality of virtual world servers where the at least one parameter is above the predetermined threshold. As discussed above, the load balancer 406 can then choose the server 408 with the highest FoM as the best candidate. If that server 408 is unable to meet policy considerations, the server 408 with the next highest FoM is chosen. This is repeated until a server is found.

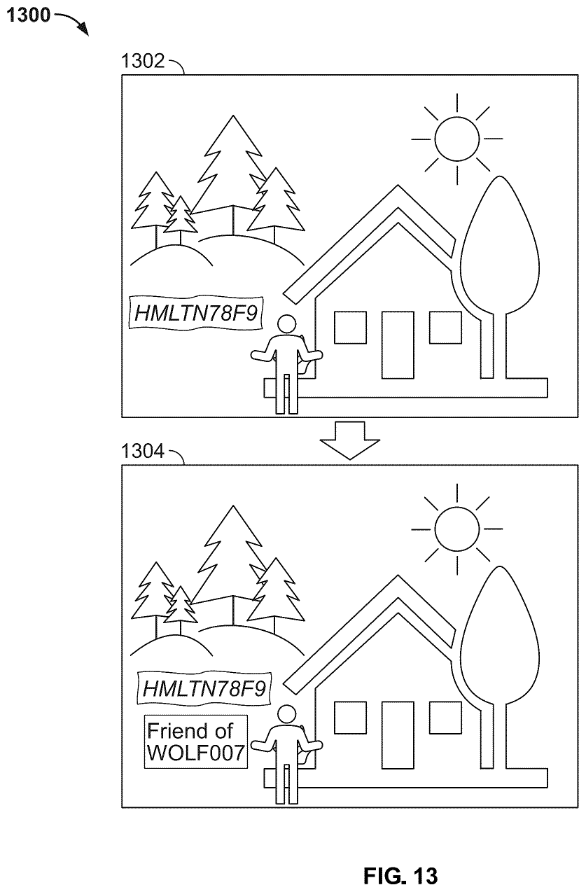

FIG. 13 illustrates a user interface 1300 involved in maximizing a likelihood of interaction with users, in accordance with some embodiments of the disclosure. Since the system 400 has chosen a server for a user that maximizes likelihood of interaction with friends, friends of friends etc., the system can present additional information to a user 102 about other users that are connected to him/her through more than one hop. FIG. 13 shows an example user presentation 1302 in the social world. Here a user spots HMLTN78F9, who is 2-hop connected to the user through WOLF007. In another embodiment 1304, the system may provide visual indicators to the user for some other users that are connected to him/her—such as a hued outline, or another shape (such as an arrow or inverted triangle) that moves together with the users. Such visual indicators may be used to identify friends, friends of friends, friends of friends of friends etc. In another embodiment, a subgraph of the server's online friendship graph is displayed when a first user hovers their controller over a second user. The relationships through which the first user is connected to the second user can then be grasped through the subgraph.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be example and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving a request to connect a client device to one of a plurality of virtual world servers;
accessing social network connectivity data of a user account associated with the client device;
identifying a plurality of other user accounts based on the social network connectivity data;
ranking the plurality of virtual world servers based on connections with devices associated with the plurality of other user accounts; and
connecting the client device to a virtual world server of the plurality of virtual world servers based on the ranking.

2. The method of claim 1, wherein identifying a plurality of other user accounts based on the social network connectivity data further comprises:
receiving metadata from a server;
determining, from the metadata, a friendship graph comprising the plurality of other users; and
determining, from the metadata, an online friendship graph comprising a subset of the plurality of other users.

3. The method of claim 2, wherein ranking the plurality of virtual world servers based on connections with devices associated with the plurality of other user accounts further comprises;
determining, from the metadata, a static online friendship graph; or
determining, from the metadata, a dynamic online friendship graph.

4. The method of claim 3, wherein:
the online friendship graph comprises a node for each of the plurality of users and a plurality of vertices coupling the plurality of nodes to indicate friendships between each of the plurality of users;
the static online friendship graph further comprises:
a first node for a first user and a second node for a second user coupled by a single vertex representing a one-hop friendship connection between the first user and the second user,
the first node for the first user and the second node for the second user coupled by two vertices representing a two-hop friendship connection between the first user and the second user, and
the first node for the first user and the second node for the second user coupled by n-vertices representing an n-hop friendship connection between the first user and the second user, wherein a one-hop friendship connection represents a close friendship, and the level of friendship decreases with each hop; and
in the dynamic online friendship graph each vertex between two nodes is given a weighting to determine a level of friendship, wherein the weighting is determined based on any one of:
a time of interaction between two users,
frequency of interaction between two users, and/or
positivity of interaction between the two users, wherein a higher weighting represents a close friendship and a lower weighting represents a less close friendship.

5. The method of claim 4, wherein ranking the plurality of virtual world servers based on connections with devices associated with the plurality of other user accounts further comprises:
determining, based on the level of friendship between the user of the client device and each of the plurality of users in the online friendship graph, a level of friendship between the user and each of the plurality of users in each virtual world server of the plurality of world servers; and
ranking each of the plurality of virtual world servers based on the number of close friendships, wherein the virtual world server with the highest number of close friendships is given the highest ranking and the virtual world server with the lowest number of close friendships is given the lowest ranking.

6. The method of claim 2, further comprising:
determining, from the metadata, at least one behavioral characteristic of the plurality of users;
wherein the at least one behavioral characteristic comprises any one of:
a period of time spent online,
a period of time spent in any one of the plurality of virtual world servers, and/or
a level of interaction with other users of the plurality of users;
determining, based on the at least one behavioral characteristic, that at least one of the plurality of users in the connected virtual world server is a lurker;
sending a request to disconnect a client device of the lurker from the virtual world server; and
connecting the client device of the lurker to a different one of the plurality of virtual world servers.

7. The method of claim 1, wherein connecting the client device to a virtual world server of the plurality of virtual world servers based on the ranking further comprises:
identifying at least one parameter for each of the plurality of virtual world servers;
determining the virtual world server of the plurality virtual world servers with the highest ranking;
connecting the client device to the virtual world server with the highest ranking if the at least one parameter of the virtual world server with the highest ranking is above a predetermined threshold; and
connecting the client device to a virtual world server with a lower ranking if the at least one parameter of the virtual world server with the highest ranking is below the predetermined threshold.

8. The method of claim 7, wherein the at least one parameter comprises any one of:
a security threshold;
a proximity threshold; and
a bandwidth threshold.

9. The method of claim 7, further comprising:
identifying, based on the at least one parameter identified for each of the plurality of virtual servers, each of the plurality of virtual world servers where the at least one parameter is above the predetermined threshold;
presenting for display on the client device each of the plurality of virtual world servers where the at least one parameter is above the predetermined threshold, based on the ranking of the plurality of virtual world servers;
receiving, at the client device, a user input; and
connecting, based on the user input, the client device to a virtual world server of the plurality of virtual world servers where the at least one parameter is above the predetermined threshold.

10. The method of claim 1, further comprising:
determining, subsequent to connecting the client device to a virtual world server of the plurality of world servers, a loss of connection between the client device and the virtual world server of the plurality of world servers;
connecting the client device to the same virtual world server of the plurality of world servers if the loss of connection was below a predetermined threshold period of time; and
connecting the client device to a different virtual world server of the plurality of world servers if the loss of connection was above a predetermined threshold period of time.

11. An apparatus comprising:
a memory storing instructions;
communication paths; and
control circuitry coupled to the communication paths and the memory and configured to execute the instructions to:
receive a request to connect a client device to one of a plurality of virtual world servers;
access social network connectivity data of a user account associated with the client device;
identify a plurality of other user accounts based on the social network connectivity data;
rank the plurality of virtual world servers based on connections with devices associated with the plurality of other user accounts; and
connect the client device to a virtual world server of the plurality of virtual world servers based on the ranking.

12. The apparatus of claim 11, wherein to identify a plurality of other user accounts based on the social network connectivity data further comprises the control circuitry to:
receive metadata from a server;
determine, from the metadata, a friendship graph comprising the plurality of other users; and
determine, from the metadata, an online friendship graph comprising a subset of the plurality of other users.

13. The apparatus of claim 12, wherein to rank the plurality of virtual world servers based on connections with devices associated with the plurality of other user accounts further comprises the control circuitry to;
determine, from the metadata, a static online friendship graph; or
determine, from the metadata, a dynamic online friendship graph.

14. The apparatus of claim 13, wherein
the online friendship graph comprises a node for each of the plurality of users and a plurality of vertices coupling the plurality of nodes to indicate friendships between each of the plurality of users;
the static online friendship graph further comprises:
a first node for a first user and a second node for a second user coupled by a single vertex representing a one-hop friendship connection between the first user and the second user,
the first node for the first user and the second node for the second user coupled by two vertices representing a two-hop friendship connection between the first user and the second user, and
the first node for the first user and the second node for the second user coupled by n-vertices representing an n-hop friendship connection between the first user and the second user, wherein a one-hop friendship connection represents a close friendship, and the level of friendship decreases with each hop; and
in the dynamic online friendship graph each vertex between two nodes is given a weighting to determine a level of friendship, wherein the weighting is determined based on any one of:
a time of interaction between two users,
frequency of interaction between two users, and/or
positivity of interaction between the two users, wherein a higher weighting represents a close friendship and a lower weighting represents a less close friendship.

15. The apparatus of claim 14, wherein to rank the plurality of virtual world servers based on connections with devices associated with the plurality of other user accounts further comprises the control circuitry to:
determine, based on the level of friendship between the user of the client device and each of the plurality of users in the online friendship graph, a level of friendship between the user and each of the plurality of users in each virtual world server of the plurality of world servers; and
rank each of the plurality of virtual world servers based on the number of close friendships, wherein the virtual world server with the highest number of close friendships is given the highest ranking and the virtual world server with the lowest number of close friendships is given the lowest ranking.

16. The apparatus of claim 12, further comprising the control circuitry to:
determine, from the metadata, at least one behavioral characteristic of the plurality of users;
wherein the at least one behavioral characteristic comprises any one of:
a period of time spent online,
a period of time spent in any one of the plurality of virtual world servers, and/or
a level of interaction with other users of the plurality of users;
determine, based on the at least one behavioral characteristic, that at least one of the plurality of users in the connected virtual world server is a lurker;
send a request to disconnect a client device of the lurker from the virtual world server; and
connect the client device of the lurker to a different one of the plurality of virtual world servers.

17. The apparatus of claim 11, wherein to connect the client device to a virtual world server of the plurality of virtual world servers based on the ranking further comprises the control circuitry to:
identify at least one parameter for each of the plurality of virtual world servers;
determine the virtual world server of the plurality virtual world servers with the highest ranking;
connect the client device to the virtual world server with the highest ranking if the at least one parameter of the virtual world server with the highest ranking is above a predetermined threshold; and
connect the client device to a virtual world server with a lower ranking if the at least one parameter of the virtual world server with the highest ranking is below the predetermined threshold.

18. The apparatus of claim 17, wherein the at least one parameter comprises any one of:
a security threshold;
a proximity threshold; and
a bandwidth threshold.

19. The apparatus of claim 17, further comprising the control circuitry to:
identify, based on the at least one parameter identified for each of the plurality of virtual servers, each of the plurality of virtual world servers where the at least one parameter is above the predetermined threshold;
present for display on the client device each of the plurality of virtual world servers where the at least one parameter is above the predetermined threshold, based on the ranking of the plurality of virtual world servers;
receive, at the client device, a user input; and
connect, based on the user input, the client device to a virtual world server of the plurality of virtual world servers where the at least one parameter is above the predetermined threshold.

20. The apparatus of claim 11, further comprising the control circuitry to:
determine, subsequent to connecting the client device to a virtual world server of the plurality of world servers, a loss of connection between the client device and the virtual world server of the plurality of world servers;
connect the client device to the same virtual world server of the plurality of world servers if the loss of connection was below a predetermined threshold period of time; and
connect the client device to a different virtual world server of the plurality of world servers if the loss of connection was above a predetermined threshold period of time.

21-40. (canceled)
